(19) United States
(12) Patent Application Publication
(10) Pub. No.: US 2024/0428285 A1
(43) Pub. Date: Dec. 26, 2024

(54) INFORMATION PROCESSING APPARATUS INFORMATION PROCESSING METHOD, AND INFORMATION PROCESSING PROGRAM

(71) Applicant: Nippon Telegraph and Telephone Corporation, Tokyo (JP)

(72) Inventors: Hideaki KIN, Musashino-shi, Tokyo (JP); Tetsuya KINEBUCHI, Musashino-shi, Tokyo (JP); Taichi ASAMI, Musashino-shi, Tokyo (JP)

(21) Appl. No.: 18/700,765

(22) PCT Filed: Nov. 9, 2021
(86) PCT No.: PCT/JP2021/041214

§ 371 Date: Apr. 12, 2024

(51) Int. Cl. G06Q 30/0211

(52) U.S. Cl. CPC G06Q 30/0211

(57) ABSTRACT

An information processing apparatus according to an embodiment includes an acquisition unit configured to acquire action history data for each user and a condition for optimizing an incentive measure; a parameter estimation unit configured to estimate a parameter value of an action model for the each user on the basis of the action history data; an optimization unit configured to calculate an optimum incentive measure for the each user on the basis of the estimated parameter value and the condition; and an output unit configured to output the optimum incentive measure.

### TECHNICAL FIELD

This invention relates to an information processing apparatus, an information processing method, and an information processing program.

### BACKGROUND ART

In achieving a certain target action, it is conceivable to give an incentive and cause the target action to be achieved by the incentive.

Non Patent Literature 1 describes achievement of a target action or formation of a target habit by an incentive. For example, Non Patent Literature 1 discloses that, for the purpose of forming an exercise habit, the formation of an exercise habit of a person is promoted by providing an incentive (money) according to an amount of exercise. Further, Non Patent Literature 2 discloses that an effect of an incentive differs depending on a method of providing an incentive.

### CITATION LIST

### Non Patent Literature

Non Patent Literature 1: Finkelstein, Eric. A., et al., “A Randomized Study of Financial Incentives to Increase Physical Activity among Sedentary Older Adults”, Preventive medicine, 47 (2), pp. 182-187, 2008.
Non Patent Literature 2: Bachireddy Chethan, et al., “Effect of Different Financial Incentive Structures on Promoting Physical Activity Among Adults: A Randomized Clinical Trial”, JAMA Network Open, 2 (8), pp. 1-13, 2019.

### SUMMARY OF INVENTION

### Technical Problem

In achievement of a certain target action, the magnitude of an effect of an incentive is different for each individual even if an incentive amount is the same. However, in the conventional technology, a difference in individual response to the incentive is not considered. Therefore, there is a possibility that the incentive cannot be effectively utilized for each person. Further, in the conventional technology, an incentive provision amount of every time (every day, every week, or the like) is assumed to be any one of constant, a monotonous decrease, or a monotonous increase, but the effect of the incentive is also considered to vary according to an internal state of the person that varies day by day. Therefore, there is a possibility of a difficulty in effectively operating an incentive with a simple incentive provision method.

An incentive (for example, cash or a coupon) is directly linked to cost for an operator who intervenes with an incentive, and thus it is desirable to realize high cost-effectiveness, that is, a large effect under a smaller incentive.

The present invention has been made in view of the above circumstances, and an object of the present invention is to provide a technology capable of specifying, for each individual, the most cost-effective incentive measure for achieving the target action.

### Solution to Problem

To solve the above-described problem, the present invention is an information processing apparatus, which includes: an acquisition unit configured to acquire action history data for each user and a condition when optimizing an incentive measure; a parameter estimation unit configured to estimate a parameter value of an action model for the each user on a basis of the action history data; an optimization unit configured to calculate an optimum incentive measure for the each user on a basis of the estimated parameter value and the condition; and an output unit configured to output the optimum incentive measure.

### Advantageous Effects of Invention

According to one aspect of the present invention, it is possible to specify the most cost-effective incentive measure for each individual to achieve the target action. Further, a business operator can support achievement of the target action for each user at a smaller cost by using a highly cost-effective incentive measure. Therefore, the business operator can expand a profit or set a service usage fee low.

### BRIEF DESCRIPTION OF DRAWINGS

FIG. 1 is a block diagram illustrating an example of a hardware configuration of an information processing apparatus according to a first embodiment.

FIG. 2 is a block diagram illustrating a software configuration of the information processing apparatus of the first embodiment in association with the hardware configuration illustrated in FIG. 1.

FIG. 3 is a flowchart illustrating an example of a parameter estimation operation of the information processing apparatus.

FIG. 4 is a flowchart illustrating an example of an operation of calculating an optimum incentive measure of the information processing apparatus.

### DESCRIPTION OF EMBODIMENTS

Hereinafter, embodiments according to this invention will be described with reference to the drawings. Note that, hereinafter, the same or similar reference signs will be given to components that are the same as or similar to those already described, and redundant description will be basically omitted.

### Embodiment

### Configuration

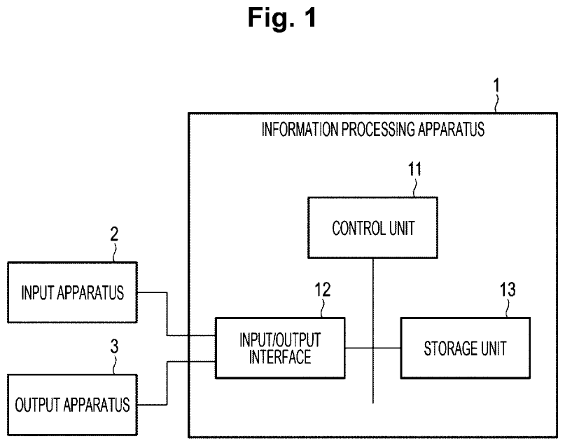

FIG. 1 is a block diagram illustrating an example of a hardware configuration of an information processing apparatus 1 according to a first embodiment.

The information processing apparatus 1 is achieved by a computer such as a personal computer (PC). The information processing apparatus 1 includes a control unit 11, an input/output interface 12, and a storage unit 13. The control unit 11, the input/output interface 12, and the storage unit 13 are communicably connected to each other via a bus.

The control unit 11 controls the information processing apparatus 1. The control unit 11 includes a hardware processor such as a central processing unit (CPU).

The input/output interface 12 is an interface that enables transmission and reception of information between an input apparatus 2 and an output apparatus 3. The input/output interface 12 may include a wired or wireless communication interface. That is, the information processing apparatus 1, the input apparatus 2, and the output apparatus 3 may transmit and receive information via a network such as a LAN or the Internet.

The storage unit 13 is a storage medium. The storage unit 13 includes a nonvolatile memory to and from which write and read can be performed at any time, such as a hard disk drive (HDD) or a solid state drive (SSD), a nonvolatile memory such as a read only memory (ROM), and a volatile memory such as a random access memory (RAM), in combination. The storage unit 13 includes a program storage area and a data storage area in a storage area. The program storage area stores an application program necessary for executing various types of processing in addition to an operating system (OS) and middleware.

The input apparatus 2 includes, for example, a keyboard, a pointing device, and the like for an owner (for example, an allocator, an administrator, a supervisor, or the like) of the information processing apparatus 1 to input an instruction to the information processing apparatus 1. Further, the input apparatus 2 can include a reader for reading data to be stored in the storage unit 13 from a memory medium such as a USB memory, and a disk apparatus for reading such data from a disk medium. Moreover, the input apparatus 2 may include an image scanner.

The output apparatus 3 includes a display that displays output data to be presented from the information processing apparatus 1 to the owner, a printer that prints the output data, and the like. Further, the output apparatus 3 can include a writer for writing data to be input to another information processing apparatus 1 such as a PC or a smartphone to a memory medium such as a USB memory, and a disk apparatus for writing such data to a disk medium.

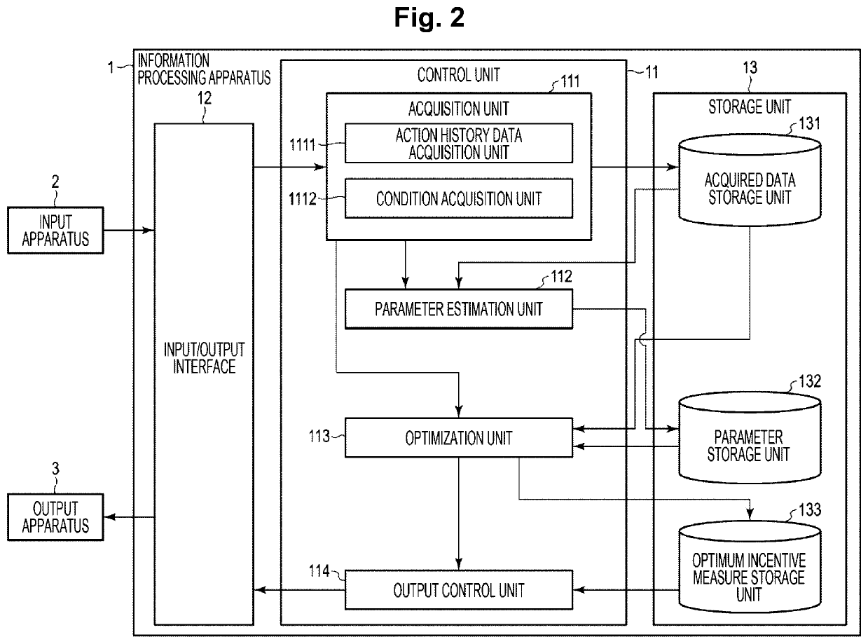

FIG. 2 is a block diagram illustrating a software configuration of the information processing apparatus 1 of the first embodiment in association with the hardware configuration illustrated in FIG. 1.

The storage unit 13 includes an acquired data storage unit 131, a parameter storage unit 132, and an optimum incentive measure storage unit 133.

The acquired data storage unit 131 stores various data acquired by an acquisition unit 111, which will be described below, of the control unit 11. The data stored in the acquired data storage unit 131 may be acquired by capturing action history data, a condition, and the like from the outside via the input apparatus 2, or may include data generated by the control unit 11. Note that the action history data and the condition will be described below.

The parameter storage unit 132 stores a parameter value of an action model estimated by a parameter estimation unit 112 to be described below. Note that the action model and the parameter value of the action model will be described below.

The optimum incentive measure storage unit 133 stores an optimum incentive measure calculated by an optimization unit 113 to be described below. Note that the optimum incentive measure will be described below.

The control unit 11 includes the acquisition unit 111, the parameter estimation unit 112, the optimization unit 113, and an output control unit 114. These functional units are achieved by the hardware processor described above executing an application program stored in the storage unit 13.

The acquisition unit 111 acquires necessary data and causes the acquired data storage unit 131 to store the data. The acquisition unit 111 includes an action history data acquisition unit 1111 and a condition acquisition unit 1112.

The action history data acquisition unit 1111 acquires action history data for each user from the input apparatus 2 via the input/output interface 12, and causes the acquired data storage unit 131 to store the acquired action history data. The action history data acquisition unit 1111 may separately acquire the action history data of one user, or may acquire the action histories of a plurality of users at a time in a form distinguishable from each other. Further, the action history data acquisition unit 1111 may output a signal indicating that the action history data has been acquired to the parameter estimation unit 112. Note that the acquired action history data will be described below.

The condition acquisition unit 1112 acquires the condition for each user from the input apparatus 2 via the input/output interface 12, and causes the acquired data storage unit 131 to acquire the acquired condition. The condition acquisition unit 1112 may separately acquire the condition for one user, or may acquire the conditions for a plurality of users at a time in a form distinguishable from each other. Further, the condition acquisition unit 1112 may output a signal indicating that the condition has been acquired to the optimization unit 113. Note that the acquired condition will be described below.

The parameter estimation unit 112 estimates a parameter value of a mathematical model (action model) having an incentive amount as an input and an achievement level for a target action as an output, for each user, on the basis of the action history data stored in the acquired data storage unit 131. Moreover, the parameter estimation unit 112 causes the parameter storage unit 132 to store the estimated parameter value. Here, the incentive amount, the target action, and the action model will be described below.

The optimization unit 113 calculates an optimum incentive measure on the basis of the parameter value estimated by the parameter estimation unit 112 and the condition stored in the acquired data storage unit 131. The optimization unit 113 calculates the optimum incentive measure for each user. Further, the optimization unit 113 causes the optimum incentive measure storage unit 133 to store the calculated optimum incentive measure. Here, details of the optimum incentive measure will be described below.

After the parameter value is estimated for an arbitrary user on the basis of the action history data of the user, the output control unit 114 outputs the optimum incentive measure stored in the optimum incentive measure storage unit 133 to the output apparatus 3 via the input/output interface 12 in response to acquisition of the condition from the input apparatus 2. Furthermore, after the optimum incentive measure is calculated on the basis of the parameter value and the condition for the arbitrary user, the output control unit 114 may output the optimum incentive measure for the arbitrary user stored in the optimum incentive measure storage unit 133 to the output apparatus 3 via the input/output interface 12 in response to the operation of the user of the information processing apparatus 1.

### Operation

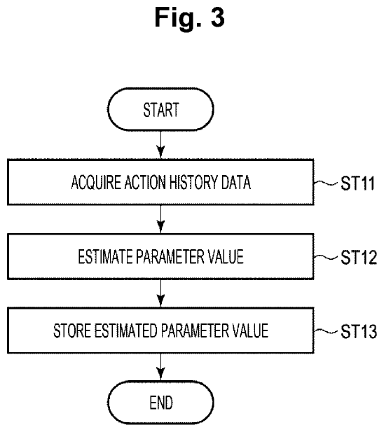

FIG. 3 is a flowchart illustrating an example of a parameter estimation operation of the information processing apparatus 1.

The control unit 11 of the information processing apparatus 1 reads and executes the program stored in the storage unit 13, thereby achieving the operation of this flowchart.

The operation may be started at arbitrary timing. For example, the operation may be automatically started at regular time intervals, or may be started with an operation of the owner of the information processing apparatus as a trigger.

In step ST11, the action history data acquisition unit 1111 acquires the action history data from the input apparatus 2 via the input/output interface 12. For example, the user may input the action history data to the input apparatus 2. Alternatively, the action history data acquisition unit 1111 may acquire the action history data stored in an external server or the like via the input/output interface 12. Then, the action history data acquisition unit 1111 causes the acquired data storage unit 131 to store the acquired action history data. Further, the action history data acquisition unit 1111 may output a signal indicating that the action history data has been acquired to the parameter estimation unit 112. Alternatively, the action history data acquisition unit 1111 may output the action history data to the parameter estimation unit 112.

Here, the action history data includes various types of information at each observation time for each user. For example, the action history data includes a user ID (hereinafter, represented as u), a total number of users (hereinafter, represented as U), a length of a period (hereinafter, represented as T^{u}) of a targeted action (target action) of the user u, a sequence of observation values (hereinafter, represented as the following expression) of the target action at each observation time of the user u,

$$\{ {y}_{t}^{u} \} ≡ ( {y}_{1}^{u} , {y}_{2}^{u} , … , {y}_{{T}^{u}}^{u} ) \qquad [ Math . 1 ]$$

a sequence of incentive amounts (hereinafter, represented as the following expression) presented at each observation time of the user u,

$$\{ {a}_{ι}^{u} \} ≡ ( {a}_{1}^{u} , {a}_{2}^{u} , … , {a}_{{T}^{u}}^{u} ) \qquad [ Math . 2 ]$$

and a sequence of explanatory variables (hereinafter, represented as the following expression) at each observation time of the user u.

$$\{ {e}_{t}^{u} \} ≡ ( {e}_{1}^{u} , {e}_{2}^{u} , … , {e}_{{T}^{u}}^{u} ) \qquad [ Math . 3 ]$$

Here, the observation value {y^{u}ₜ} of the target action is a numerical value obtained by evaluating success or failure of the targeted action, and takes 0 (failure) or 1 (success). Moreover, the explanatory variable {e^{u}ₜ} is a day of a week, weather, or the like, and is information that can affect the target action of the user other than the incentive. The incentive amount {a^{u}ₜ} may be, for example, money, points, or the like. Further, the action history data may be, for example, data of a result of acquiring the above-described information for each user using an action observation device or the like including a sensor or the like.

In step ST12, the parameter estimation unit 112 estimates the parameter value. When receiving the signal indicating that the action history data has been acquired from the action history data acquisition unit 1111, the parameter estimation unit 112 acquires the action history data stored in the acquired data storage unit 131. Further, in the case of directly receiving the action history data from the action history data acquisition unit 1111, the parameter estimation unit 112 may use the received action history data. Then, the parameter estimation unit 112 estimates, for each user u, the parameter value of the action model having the incentive amount included in the action history data as an input and the achievement level for the target action as an output.

The action model has self-efficacy (hereinafter, represented as x^{u}ₜ) as an internal variable. The self-efficacy is proposed as a leading factor of human action in social cognitive theory, and it is known that the self-efficacy is enhanced by an achievement experience, that is, an experience of achieving a past goal. Then, it is assumed that the self-efficacy varies with time depending on the success or failure of the past action, and follows the following expression.

$$\begin{matrix}[ Math . 4 ] & \\ {x}_{t + 1}^{u} = ( 1 - {β}^{u} ) {x}_{t}^{u} + {β}^{u} {y}_{t}^{u} & ( 1 )\end{matrix}$$

Here, β^{u} represents a forgetting rate. The forgetting rate is, for example, a value indicating how much one stored once can be stored over time. Expression (1) is an expression in which the self-efficacy at the next observation time is large when an interval from the current observation time is short, and when the target action is achieved (succeeded), the achievement is taken into account. When the internal variable (hereinafter, represented as m^{u}ₜ) that determines the probability of success or failure of the target action is referred to as motivation, the motivation can be expressed as follows, assuming that the motivation is determined by the self-efficacy, the presented incentive amount, and the explanatory variable.

$$\begin{matrix}[ Math . 5 ] & \\ {m}_{t}^{u} = {x}_{t}^{u} + h ( {a}_{t}^{u} \vert {θ}_{h}^{u} ) + g ( {e}_{i}^{u} \vert {θ}_{e}^{u} ) . & ( 2 )\end{matrix}$$

Here, h(a^{u}ₜ|θ^{u}ₕ) is a function that represents sensitivity of the user u to the incentive amount, and has a parameter value θ^{u}ₕ. Further, g(e^{u}ₜ|θ^{u}ₑ) is a function that represents an influence level on the explanatory variable of the user u, and has a parameter value θ^{u}ₑ. It is assumed that the observation value y^{u}ₜ of the target action at time t for each user is probabilistically generated from a following binomial distribution P(y^{u}ₜ) on the basis of motivation.

$$\begin{matrix}[ Math . 6 ] & \\ P ( {y}_{t}^{u} ) = {σ ( {m}_{t}^{u} \vert {θ}_{σ}^{u} )}^{{y}_{t}^{u}} {( 1 - σ ( {m}_{t}^{u} \vert {θ}_{σ}^{u} ) )}^{1 - {y}_{t}^{u}} & ( 3 )\end{matrix}$$

Here, σ(⋅|θ^{u}_{σ}) is a non-negative function that satisfies the following condition, and has a parameter value θ^{u}_{σ}.

$$\begin{matrix}[ Math . 7 ] & \\ 0 < σ ( \cdot \vert {θ}_{σ}^{u} ) < 1 & ( 4 )\end{matrix}$$

The action model defined above has a following user-specific parameter value (hereinafter, represented as θ^{u}).

$$\begin{matrix}[ Math . 8 ] & \\ {θ}^{u} = ( {β}^{u} , {θ}_{h}^{u} , {θ}_{e}^{u} , {θ}_{σ}^{u} ) & ( 5 )\end{matrix}$$

This parameter value is estimated by the parameter estimation unit 112 on the basis of a maximum likelihood estimation method expressed by the following expression.

$$\begin{matrix}[ Math . 9 ] & \\ {\overline{θ}}^{u} = arg {max}_{{θ}^{u}} {L}^{u} ( {θ}^{u} ) , {L}^{u} ( {θ}^{u} ) = {\prod }_{t = 0}^{{T}^{u}} P ( {y}_{t}^{u} ) & ( 6 )\end{matrix}$$

That is, the parameter estimation unit 112 estimates the parameter value θ^{u} of the action model for each user on the basis of the action history data.

In step ST13, the parameter estimation unit 112 causes the parameter storage unit 132 to store the estimated parameter value.

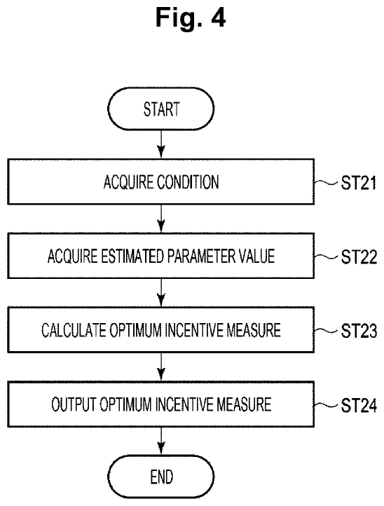

FIG. 4 is a flowchart illustrating an example of an operation of calculating an optimum incentive measure of the information processing apparatus 1.

The control unit 11 of the information processing apparatus 1 reads and executes the program stored in the storage unit 13, thereby achieving the operation of this flowchart.

The operation may be started at arbitrary timing. For example, the operation may be automatically started at regular time intervals, or may be started with an operation of the owner of the information processing apparatus as a trigger.

In step ST21, the condition acquisition unit 1112 acquires the condition from the input apparatus 2 via the input/output interface 12. For example, the user may input the condition to the input apparatus 2. Alternatively, the action history data acquisition unit 1111 may acquire the condition stored in an external server or the like via the input/output interface 12. Then, the condition acquisition unit 1112 causes the acquired data storage unit 131 to store the acquired condition. Further, the condition acquisition unit 1112 may output a signal indicating that the condition has been acquired to the optimization unit 113. Alternatively, the condition acquisition unit 1112 may output the condition to the optimization unit 113.

The condition includes a length (hereinafter, represented as E^{u}) of the target period, a total budget (hereinafter, represented as B) used for the incentive in the target period, and a sequence of explanatory variables in the target period (hereinafter, represented as the following expression),

$$\{ {e}_{t}^{u} \} ≡ ( {e}_{1}^{u} , {e}_{2}^{u} , … , {e}_{{Ξ}^{u}}^{u} ) \qquad [ Math . 10 ]$$

and an objective function (hereinafter, represented as Z) for evaluating the optimality of the incentive measure. Here, the incentive measure that maximizes an expected value of the objective function is defined as an optimum incentive measure. The objective function Z may be, for example, a following total number of successes of the target action in the target period.

$$Z = {\sum }_{t = 1}^{T} {y}_{t}^{u} \qquad [ Math . 11 ]$$

The objective function Z may also be a following sum of the total number of successes and weighting of a total incentive amount paid, or the like.

$$Z = {\sum }_{t = 1}^{T} {y}_{t}^{u} ( 1 - {ca}_{t}^{u} ) \qquad [ Math . 12 ]$$

Here, c is a weight. Further, it is a matter of course that the objective function Z is not limited to the above-described examples.

In step ST22, the optimization unit 113 acquires the parameter value stored in the parameter storage unit 132. When receiving the signal indicating that the condition has been acquired, the optimization unit 113 acquires the parameter value stored in the parameter storage unit 132. Moreover, the optimization unit 113 acquires the condition stored in the acquired data storage unit 131. Further, in the case of directly receiving the condition from the condition acquisition unit 1112, the optimization unit 113 may use the received condition.

In step ST23, the optimization unit 113 calculates the optimum incentive measure. The optimization unit 113 calculates the optimum incentive measure based on a reinforcement learning theory for each user u∈{1, 2, . . . , U}. Here, the incentive measure is defined as a function f^{u} that has the time t, the self-efficacy xᵤ^{t} at the time t, an available remaining budget (hereinafter, represented as but) of the total budget at the time t, and the explanatory variable et at the time t as inputs, and outputs the incentive amount a^{u}ₜ presented at the time t, and is expressed by the following expression.

$$\begin{matrix}[ Math . 13 ] & \\ {a}_{t}^{u} = {f}^{u} ( t , {x}_{t}^{u} , {b}_{t}^{u} , {e}_{t}^{u} ) & ( 7 )\end{matrix}$$

Moreover the optimum incentive measure is a measure that maximizes the expected value of the objective function Z as described above, and is expressed by the following expression.

$$\begin{matrix}[ Math . 14 ] & \\ {f}^{{u}^{*}} = arg {max}_{{f}^{u}} E [ Z ] & ( 8 )\end{matrix}$$

Here, E[⋅] represents the expected value. A state V^{u}ₜ at the time t is defined as follows under the action model described in step ST12 with reference to FIG. 3.

$${V}_{t}^{u} = ( t , {x}_{t}^{u} , {b}_{t}^{u} , {e}_{t}^{u} , {y}_{t}^{u} ) \qquad [ Math . 15 ]$$

The state V^{u}ₜ follows a Markov decision process (hereinafter, represented as MDP) as follows. Here, the state V^{u}ₜ at the time t has the self-efficacy, the remaining budget, the explanatory variable, and the observation value of the action as a function.
At the time t, the observation value y^{u}ₜ of the target action when the incentive amount a^{u}ₜ is presented is probabilistically generated according to Expression (3). Here, it is assumed that a possible value of the incentive amount a^{u}ₜ is equal to or less than the remaining budget b^{u}ₜ:
After generation of the observation value y″t of the target action, a state transition from the time t to time (t+1) is executed with a probability of 1.

$$\begin{matrix}[ Math . 16 ] & \\ t \to t + 1 & ( 9 )\end{matrix}$$

$${e}_{t}^{u} \to {e}_{t + 1}^{u}$$

$${x}_{t}^{u} \to ( 1 - {β}^{u} ) {x}_{t}^{u} + {β}^{u} {y}_{t}^{u}$$

$${b}_{t}^{u} \to {b}_{t}^{u} - {y}_{t}^{u} {a}_{t}^{u}$$

In the MDP, the measure for maximizing the expected value of the objective function z is obtained by, for example, solving the Bellman optimization equation. For example, an incentive measure f* that satisfies Expression (8) can also be obtained by solving the Bellman optimization equation. Here, the method of solving the Bellman optimization equation may be, for example, Deep Q Network using a neural network. This Deep Q Network using a neural network is described in, for example, Non Patent Literature “Volodymyr Mnih et al., “Playing Atari with Deep Reinforcement Learning”, arXiv, 2013”, or the like.

In the case of solving the Bellman optimization equation using the Deep Q Network, for example, an optimized incentive measure f^{u}* is given by Expression (10), using a following action value function.

$$Q ( {V}_{t}^{u} , {a}_{t}^{u} ) \qquad [ Math . 17 ]$$

The action value function is approximated by a neural network.

$$\begin{matrix}[ Math . 18 ] & \\ {f}^{{u}^{*}} = arg {max}_{{a}_{t}^{u}} Q ( {V}_{t}^{u} , {a}_{t}^{u} ) & ( 10 )\end{matrix}$$

The optimization unit 113 causes the optimum incentive measure storage unit 133 to store the calculated optimum incentive measure. Further, the optimization unit 113 may output a signal indicating that the optimum incentive measure has been stored in the optimum incentive measure storage unit 133 to the output control unit 114. Alternatively, the optimization unit 113 may directly output the optimum incentive measure to the output control unit 114.

In step ST24, the output control unit 114 outputs the optimum incentive measure. When receiving the signal indicating that the optimum incentive measure has been stored in the optimum incentive measure storage unit 133 from the optimization unit 113, the output control unit 114 acquires the optimum incentive measure f^{u}* from the optimum incentive measure storage unit 133. Alternatively, in the case of directly receiving the optimum incentive measure f^{u}* from the optimization unit 113, the output control unit 114 may use the received optimum incentive measure. Then, the output control unit 114 outputs the optimum incentive measure f^{u}* to the output apparatus 3 via the input/output interface 12. Here, the optimum incentive measure f^{u}* output to the output apparatus 3 as expressed by Expression (10) is the parameter value of the neural network model.

In this way, by inputting the action history data and the condition to the input apparatus 2, the user can acquire the optimum incentive measure f^{u}* from the output apparatus 3.

### Operation and Effect

According to the embodiment, it is possible to specify the most cost-effective incentive measure for each individual to achieve the target action. Further, a business operator can support achievement of the target action for each user at a smaller cost by using a highly cost-effective incentive measure. Therefore, the business operator can expand a profit or set a service usage fee low.

### Other Embodiments

Note that this invention is not limited to the embodiments described above. For example, in the present invention, an example of solving the Bellman optimization equation using Deep Q Network has been described, but the present invention is not limited thereto. For example, the Bellman optimization equation may be solved by approximation using a multilayer perceptron. That is, a general method can be applied as a method of solving the Bellman optimization equation.

In addition, the methods described in the above-described embodiments can be stored in a storage medium such as a magnetic disk (floppy (registered trademark) disk, hard disk, or the like), an optical disk (CD-ROM, DVD, MO, or the like), or a semiconductor memory (ROM, RAM, flash memory, or the like) as programs (software means) that can be implemented by a computing machine (computer), or can also be distributed by being transmitted through a communication medium. Note that the programs stored on the medium side also include a setting program for configuring, in the computing machine, a software means (not only an execution program but also tables and data structures are included) to be executed by the computing machine. A computer that achieves the present apparatus reads a program stored in a storage medium, constructs a software means by a setting program as the case may be, and executes the above-described processing by the operation being controlled by the software means. Note that the storage medium described in the present specification is not limited to a storage medium for distribution, and includes a storage medium such as a magnetic disk or a semiconductor memory provided in a device connected inside a computer or via a network.

In short, this invention is not limited to the embodiments described above, and various modifications can be made in the implementation stage without departing from the gist thereof. In addition, the embodiments may be implemented in appropriate combination if possible, and in this case, combined effects can be obtained. Further, the embodiments described above include inventions at various stages, and various inventions can be extracted by appropriate combinations of a plurality of disclosed components.

### REFERENCE SIGNS LIST

1 Information processing apparatus
11 Control unit
111 Acquisition unit
1111 Action history data acquisition unit
1112 Condition acquisition unit
112 Parameter estimation unit
113 Optimization unit
114 Output control unit
12 Input/output interface
13 Storage unit
131 Acquired data storage unit
132 Parameter storage unit
133 Optimum incentive measure storage unit
2 Input apparatus
3 Output apparatus

1. An information processing apparatus comprising:
an acquisition unit configured to acquire action history data for each user and a condition when optimizing an incentive measure;
a parameter estimation unit configured to estimate a parameter value of an action model for the each user on the basis of the action history data;
an optimization unit configured to calculate an optimum incentive measure for the each user on a basis of the estimated parameter value and the condition; and
an output unit configured to output the optimum incentive measure.

2. The information processing apparatus according to claim 1, wherein
the action history data includes a sequence of incentive amounts at each observation time for the each user, and
the parameter estimation unit estimates the parameter value of the action model for the each user, the action model having the sequence of incentive amounts as an input and an achievement level for a targeted action for the each user as an output.

3. The information processing apparatus according to claim 2, wherein
the action history data further includes an observation value of a target action obtained by evaluating success or failure of the targeted action at each observation time for the each user, and an explanatory variable that is information that affects the targeted action at each observation time for the each user, and
the action model for the each user includes, as internal variables, a self-efficacy that varies with time depending on success or failure of a past action and a motivation that determines success or failure of the target action, and the motivation is determined by the self-efficacy, a function that represents sensitivity to the incentive amount for the each user, and a function that represents an influence level on the explanatory variable.

4. The information processing apparatus according to claim 3, wherein, in the action model for the each user, an action at each observation time for the each user is larger than 0 and smaller than 1, and the action model is probabilistically generated from a binomial distribution represented by a non-negative function having the motivation as the internal variable, and the parameter estimation unit estimates the parameter value of the action model for the each user on the basis of a maximum likelihood estimation method.

5. The information processing apparatus according to claim 4, wherein the condition includes a length of a target period, a total budget used for an incentive in the target period, a sequence of the explanatory variables in the target period, and an objective function that evaluates optimality of an incentive measure, the incentive measure is a function that has time, the self-efficacy at the time, a remaining budget of the total budget available for the incentive measure, and the explanatory variable as inputs, and outputs the incentive amount presented at the time, and the optimum incentive measure is an incentive measure that maximizes an expected value of the objective function.

6. The information processing apparatus according to claim 5, wherein, in a Markov decision process in which a state at the time includes the self-efficacy, the remaining budget, the explanatory variable, and an observation value of the action, the observation value of the target action when the incentive amount is presented at the time is probabilistically generated according to the binomial distribution, a possible value of the incentive amount is equal to or less than the remaining budget, and transition is performed with a probability of 1 from the time to next time, the optimization unit calculates the optimum incentive measure by solving a Bellman optimization equation.

7. An information processing method executed by an information processing apparatus including a processor, the information processing method comprising:
acquiring, by the processor, action history data for each user;
acquiring, by the processor, a condition when optimizing an incentive measure;
estimating, by the processor, a parameter value of an action model for the each user on the basis of the action history data;
calculating an optimum incentive measure for the each user on the basis of the estimated parameter value and the condition; and
outputting, by the processor, the optimum incentive measure.

8. A non-transitory computer readable storage medium storing a computer program which is executed by an information processing apparatus to provide the steps of:
acquiring, by a processor, action history data for each user;
acquiring, by the processor, a condition when optimizing an incentive measure;
estimating, by the processor, a parameter value of an action model for the each user on the basis of the action history data;
calculating an optimum incentive measure for the each user on the basis of the estimated parameter value and the condition; and
outputting, by the processor, the optimum incentive measure.
